(19) United States
(12) Patent Application Publication
(10) Pub. No.: US 2008/0032843 A1
(43) Pub. Date: Feb. 7, 2008

(54) Transaxle

(76) Inventors: Tomoyuki EBIHARA, Amagasaki-shi (JP); Hiroshi TOTTORI, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/832,897

(22) Filed: Aug. 2, 2007

(30) Foreign Application Priority Data
Aug. 4, 2006 (JP) JP 2006-213676

(51) Int. Cl. F16H 47/04

(52) U.S. Cl. 475/83

(57) ABSTRACT

A transaxle for a vehicle comprises: an axle; an input shaft disposed perpendicular to the axle; a transmission interposed between the input shaft and the axle; a transaxle casing incorporating the axle, the input shaft and the transmission, the transaxle casing having opposite sides in a direction parallel to the axle; and a brake unit for braking the axle, the brake being provided on one of the opposite sides of the transaxle casing in the direction parallel to the axle.

### BACKGROUND OF THE INVENTION

1. Field of the Invention

The present invention relates to a transaxle, especially adaptable to an all-terrain vehicle such as a buggy.

2. Related Art

As disclosed in Japanese Patent No. 3052075, there is a well-known conventional transaxle for a buggy. The conventional transaxle includes an input casing, a middle casing and a deceleration gear casing joined to one another. The input casing supports a fore-and-aft input shaft. The deceleration gear casing incorporates deceleration gears and supports lateral axles driven by the deceleration gears. The middle casing is interposed between the input casing and the deceleration gear casing so as to incorporate a fore-and-aft transmission shaft, which is coaxially connected to the fore-and-aft input shaft and drivingly connected to the deceleration gears. In the middle casing, a brake is provided on the transmission shaft. The middle casing is removable from the transaxle for maintenance of the brake.

However, in the conventional transaxle, the middle casing is sandwiched between the input casing and the deceleration gear casing. Thus, to remove the middle casing from the transaxle, the input casing and the deceleration gear casing have to be separated from each other so as to have a vacant space therebetween, thereby requiring the input shaft and the deceleration gears to be separated from each other. Consequently, to ensure maintenance of the brake, the transaxle has many parts to be divided or removed, i.e., the transaxle has to be laboriously disassembled. Further, depending on whether the brake is provided to the transaxle or not, most component parts and structure of the transaxle have to be changed in design, thereby hindering the standardization of the transaxle.

Further, the deceleration gears should be bevel gears because they have to drivingly connect the fore-and-aft transmission shaft to the lateral axles. In this regard, the deceleration gears include a diametrically large final gear provided on the axles. If the final gear is made into a bevel gear, it requires complicated processing work. In this regard, if a wheel member serving as the final gear is formed integrally with a boss portion to be fitted on the axles, the boss portion obstructs the work for forming bevel-teeth on the wheel member. Thus, normally, a bevel-toothed wheel member and a boss member separated from each other are fastened to each other by bolts or joined to each other by welding, so as to constitute the final gear, thereby increasing costs.

### SUMMARY OF THE INVENTION

An object of the invention is to provide a transaxle adaptable to an all-terrain vehicle such as a buggy, improved in assembly and disassembly for maintenance of a brake unit.

To achieve the object, according to the invention, a transaxle for an all-terrain vehicle comprises: an axle; an input shaft disposed perpendicular to the axle; a transmission interposed between the input shaft and the axle; and a transaxle casing incorporating the axle, the input shaft and the transmission. One of opposite side portions of the transaxle casing in a direction parallel to the axle is provided for detachably mounting a brake unit thereon.

Therefore, the brake unit can be easily separated from the transaxle without disassembling any part other than the brake unit, so as to facilitate maintenance thereof. Further, the transaxle can be easily selectively provided with the brake unit or without the brake unit. Especially, if the transaxle is provided to a vehicle such as an all-terrain vehicle or buggy having a front transaxle having no brake, and a rear transaxle having a brake, the present transaxle can be selectively provided as either the front transaxle or the rear transaxle depending on whether the transaxle is provided with the brake unit or without the brake unit. In other words, almost all components and structure of the transaxle can be standardized regardless of whether it is provided with the brake unit or without the brake unit.

Preferably, the transmission comprises a gear train including a counter shaft disposed in the transaxle casing in parallel to the axle and between the input shaft and the axle. When the brake unit is mounted on the side portion of the transaxle casing, an outer end portion of the counter shaft is disposed in the brake unit.

Therefore, the brake unit is configured so as to brake the counter shaft of the transmission, thereby effectively braking axles. The detachment of the brake unit from the transaxle requires none of the input shaft, the gear train including the counter shaft, the axle and other parts in the transaxle casing to be disassembled, thereby facilitating maintenance of the brake unit. Further, due to the parallel arrangement of the counter shaft and the axle, gears of the gear train include spur gears interposed between the counter shaft and the axle advantageously in costs.

Further preferably, a wall of the side portion of the transaxle casing for mounting the brake unit thereon is adapted to be bored with a shaft hole for passing the counter shaft therethrough when the brake unit is mounted on the transaxle casing.

Therefore, if the transaxle is provided without the brake unit, the wall can be provided without the shaft hole, i.e., the wall can be closed so as to effectively enclose the axle, the input shaft and the transmission in the transaxle casing. Due to such an easy boring of the shaft hole in the wall for passing the counter shaft, the transaxle without the brake unit can be easily changed into a transaxle provided with the brake unit, thereby standardizing the transaxle casing.

Preferably, a fluid sump is provided in the transaxle casing, and a hole axially penetrates the counter shaft so as to have first and second opened ends. The first end is opened to the fluid sump, and the second end is opened to the brake unit. Fluid introduction means is disposed adjacent to the first end so as to introduce fluid from the fluid sump to the brake unit through the hole.

Therefore, the brake unit requires no other special means to be supplied with fluid serving as lube. The counter shaft having the axial hole is lightened and adapted for efficiently supplying lube to the brake unit from the fluid sump in the transaxle casing. Further, the axial hole of the counter shaft having the first and second ends has the whole axial length of the counter shaft so as to supply sufficient lube to the brake unit.

Preferably, a wall of the side portion of the transaxle casing for mounting the brake unit thereon is adapted to be easily bored with a hole for passing fluid therethrough between the transaxle casing and the brake unit when the brake unit is mounted on the transaxle casing.

Therefore, the hole smoothly circulates fluid between the transaxle casing and the brake unit. The hole may be provided for passing fluid from the transaxle casing to the brake unit. The fluid supplied from the transaxle casing to the brake unit suppresses the temperature rising in the brake unit so as to improve durability of the brake unit. Otherwise, the hole may be provided for passing fluid from the brake unit to the transaxle casing. The fluid returned from the brake unit to the transaxle casing prevents shortage of fluid in the transaxle casing. Further, when the transaxle casing is provided without the brake unit, the transaxle casing may be provided without the hole, so as to effectively enclose the input shaft, the transmission and the axle.

Preferably, the brake unit includes a brake casing attached to the side portion of the transaxle casing, and the brake casing has an outer surface formed thereon with fins.

Therefore, during traveling of a vehicle such as a buggy equipped with the transaxle having the brake unit, even if heat caused by friction of the brake unit and heat of lube are transferred to the brake casing, the fins efficiently radiate heat to the outside air so as to effectively cool the brake unit.

These, other and further objects, features and advantages of the invention will appear more fully from the following description with reference to accompanying drawings.

### BRIEF DESCRIPTION OF THE DRAWINGS

FIG. 1 is a side view of a buggy equipped with front and rear transaxles serving as embodiments of a transaxle according to the present invention.

FIG. 2 is a plan view of the buggy.

FIG. 3 is a side view of a non-differential type transaxle provided on a side portion thereof with a brake unit when viewed from the brake unit side.

FIG. 4 is a sectional plan view of the transaxle shown in FIG. 3, i.e., a cross sectional view taken along IV-IV line of FIG. 3.

FIG. 5 is a cross sectional view taken along V-V line of FIG. 3.

FIG. 6 is an enlarged view of a portion of FIG. 5 showing means for introducing lube for a brake into a counter shaft.

FIG. 7 is a cross sectional view taken along VII-VII line of FIG. 3.

FIG. 8 is a cross sectional view taken along VIII-VIII line of FIG. 4.

FIG. 9 is a cross sectional view taken along IX-IX line of FIG. 7.

FIG. 10 is a sectional view of a portion of the transaxle shown in FIG. 3 showing a brake cam mechanism.

FIG. 11 is a cross sectional view taken along V-V line of FIG. 3, having another structure of a fluid passage in the counter shaft for supplying lube to the brake.

FIG. 12 is a sectional plan view of a non-differential type transaxle provided with the brake unit on another side thereof opposite to the side of the transaxle shown in FIGS. 3 and 4 on which the brake unit is provided.

FIG. 13 is a sectional plan view of a differential type transaxle without the brake unit.

FIG. 14 is a sectional plan view of the differential type transaxle with the brake unit.

FIG. 15 is a skeleton diagram of a transaxle provided with a limited-slip differential unit and the brake unit.

FIG. 16 is a skeleton diagram of a transaxle provided with an automatic differential-lockable differential unit and the brake unit.

FIG. 17 is a side view of another non-differential type transaxle provided with the brake unit on another side thereof opposite to the side of the transaxle shown in FIGS. 3 and 4 on which the brake unit is provided, showing the brake unit from which a brake cover is removed, wherein a brake shaft is disposed in parallel to an input shaft.

FIG. 18 is a sectional plan view of the transaxle shown in FIG. 17.

FIG. 19 is a sectional rear view of a portion of the transaxle shown in FIG. 17 showing a part of the brake unit.

### DETAILED DESCRIPTION OF THE INVENTION

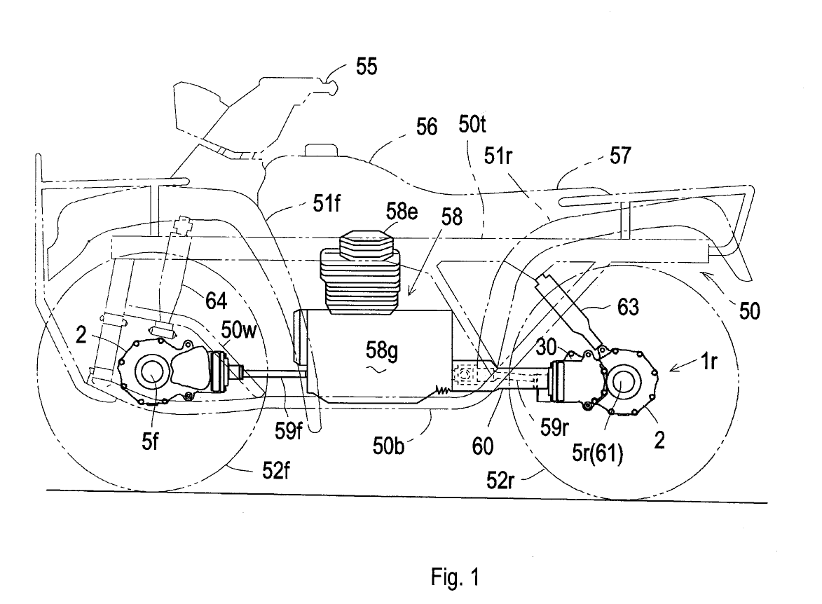

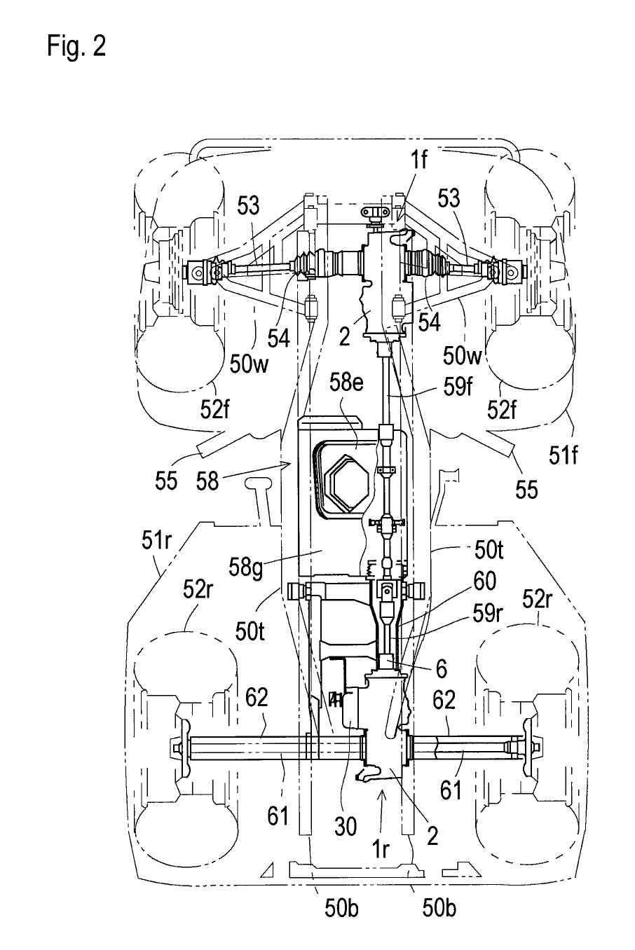

An entire structure of an all-terrain vehicle or buggy shown in FIGS. 1 and 2 will be described. The buggy is provided with a front transaxle 1f and a rear transaxle 1r. Front and rear transaxles 1f and 1r are the same transaxles fore-and-aft reversed to each other, excluding that rear transaxle 1r is provided with a brake unit 30, and front transaxle 1f is provided without brake unit 30.

An upper frame 50t and a lower frame 50b are joined to each other so as to constitute a vehicle body frame 50, which is provided on a front portion thereof with a front fender 51f, and on a rear portion thereof with a rear fender 51r.

Left and right wishbone frames 50w are vertically swingably (rollably) extended laterally from a front end portion of lower frame 50b. Left and right front suspensions 64 support swingable outer ends of respective left and right wishbone frames 50w. Further, left and right front wheels 52f are steerably supported on the swingable outer ends of respective wishbone frames 50w, and covered with front fender 51f.

A transaxle casing 2 of front transaxle 1f is fixed onto the front end portion of lower frame 50b. Left and right front extension axles 53 are extended laterally along respective left and right wishbone frames 50w. Front transaxle 1f has left and right lateral horizontal axles 5f supported in respective left and right end portions of transaxle casing 2. Front extension axles 53 are connected at proximal ends thereof to respective axles 5f through respective universal joints, and are connected at distal ends thereof to center portions of rims of respective front wheels 52f through respective universal joints. The universal joints are covered with respective boots 54. In this way, left and right front wheels 52f are steerably supported by vehicle body frame 50 so as to serve as steerable wheels to be steered by later-discussed handlebars 55, and serve as drive wheels to be driven by front transaxle 1f.

A rear suspension 63 is extended rearwardly downward from a rear portion of upper frame 50t behind lower frame 50b so as to vertically swingably (pitchably) support rear transaxle 1r. Left and right rear extension axles 61 are extended laterally from transaxle casing 2 of rear transaxle 1r. Rear extension axles 61 are fixed at distal ends thereof to center portions of rims of respective rear wheels 52r. A pair of axle casings 62 are interposed between the respective left and right ends of transaxle casing 2 of rear transaxle 1r and the rims of respective rear wheels 52r so as to entirely enclose respective rear extension axles 61. Rear transaxle 1r has left and right lateral horizontal axles 5r supported in respective left and right end portions of transaxle casing 2. In this regard, rear extension axles 61 may be separated from axles 5r and coaxially fixed to respective axles 5r. Alternatively, axles 5r may be extended outward from transaxle casing 2 so as to serve as rear extension axles 61 by themselves. In this way, left and right rear wheels 52r are unsteerable wheels, and are drive wheels to be driven by rear transaxle 1r. Rear wheels 52r are covered with rear fender 51r.

Handlebars 55, a fuel tank 56 and a saddle 57 are mounted on upper frame 50t between front wheels 52f and rear wheels 52r, so that fuel tank 56 is disposed behind handlebars 55, and saddle 57 behind fuel tank 56. A power unit 58 is mounted on lower frame 50b below fuel tank 56 and saddle 57. Power unit 58 includes a transmission gearbox 58g and an engine 58e mounted on an upper portion of transmission gearbox 58g.

A front-wheel drive shaft 59f is extended forward from transmission gearbox 58g. A rear-wheel drive shaft 59r is extended rearward from transmission gearbox 58g. Power of engine 58e is transmitted to transmission gears in transmission gearbox 58g, and is distributed between front-wheel drive shaft 59f and rear-wheel drive shaft 59r. A gear train is disposed in transaxle casing 2 of each of front and rear transaxles 1f and 1r so as to serve as a transmission of each transaxle 1f or 1r. Front-wheel drive shaft 59f is inserted at a front end thereof into a rear end portion of transaxle casing 2 of front transaxle 1f, and rear-wheel drive shaft 59r is inserted at a rear end thereof into a front end portion of transaxle casing 2 of rear transaxle 1r, so as to be drivingly connected to the gear train in each transaxle casing 2.

A shaft casing 60 is interposed between a rear end of transmission gearbox 58g and a front end of transaxle casing 2 of rear transaxle 1r so as to enclose rear-wheel drive shaft 59r. Power unit 58 has a rear-wheel drive output shaft in transmission gearbox 58g, and the rear-wheel drive output shaft is connected to a front end of rear-wheel drive shaft 59r through a universal joint or the like, so as to allow the vertical swingability of rear transaxle 1r suspended by rear suspension 63.

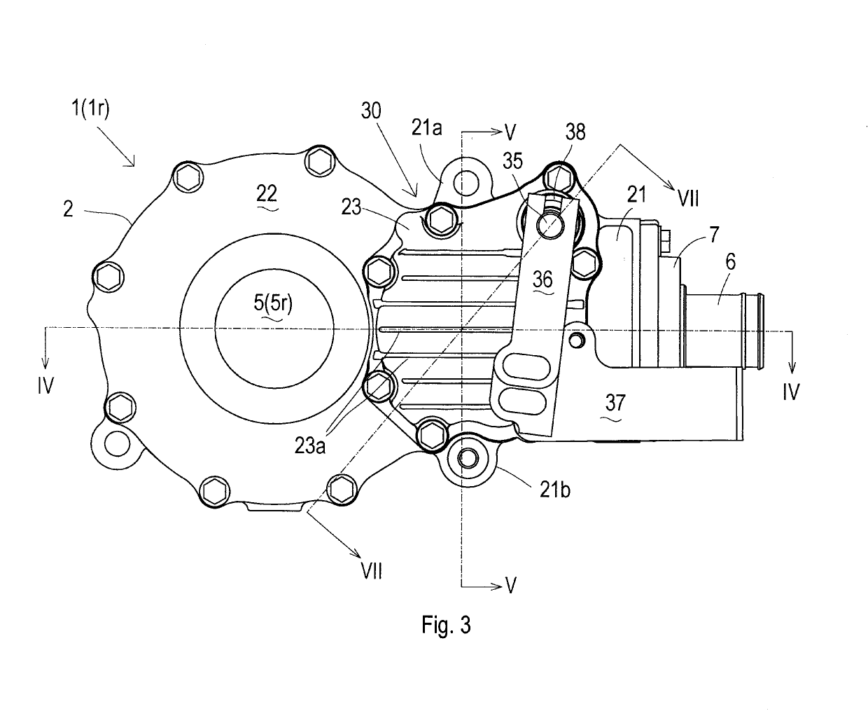

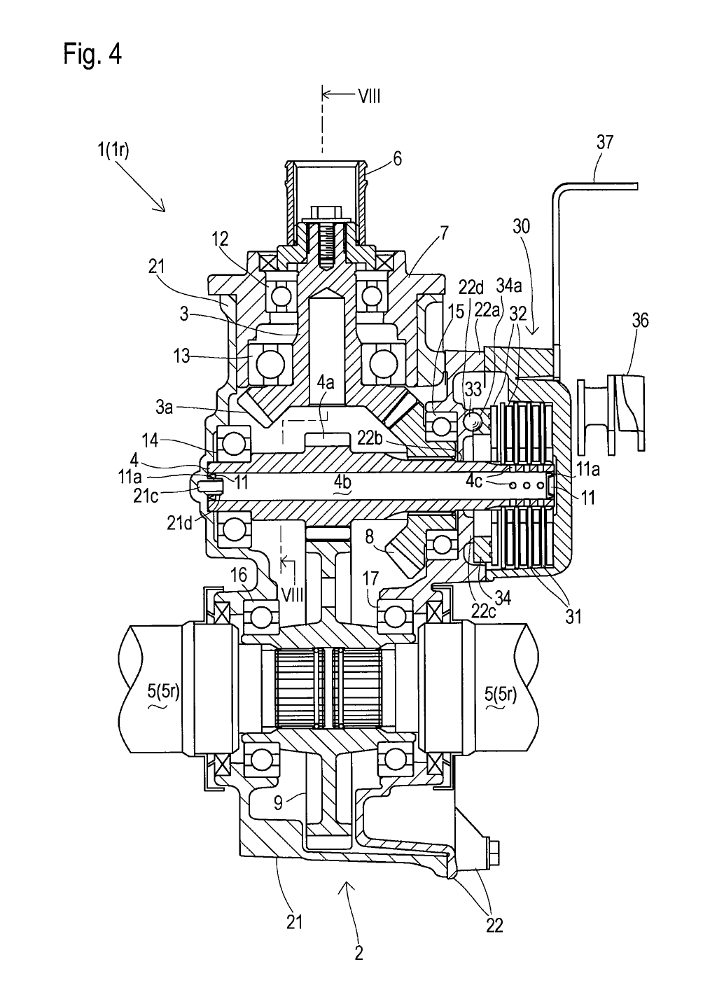

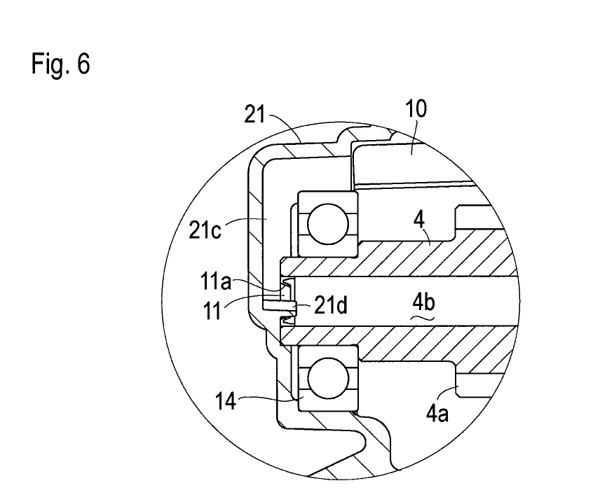

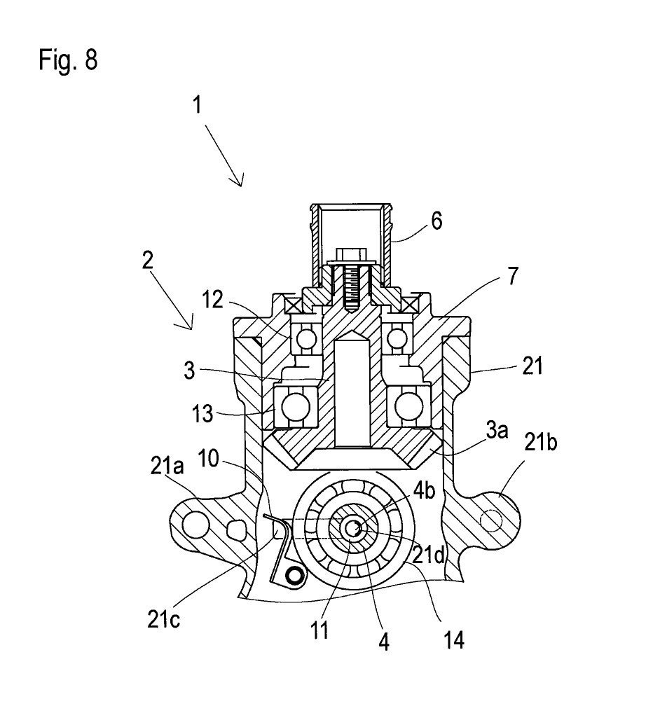

Description will be given of a transaxle 1 shown in FIGS. 3 to 10, which is adaptable as rear transaxle 1r for the buggy shown in FIGS. 1 and 2. As shown in FIG. 4 and others, an input shaft 3, a counter shaft 4 and a pair of axles 5 are journalled in transaxle casing 2 of transaxle 1. Axles 5 serve as rear axles 5r in the case that transaxle 1 serves as rear transaxle 1r. The gear train serving as the transmission of transaxle 1 is disposed in transaxle casing 2 so as to be interposed between input shaft 3 and axles 5 through counter shaft 4. Especially, as discussed later, a portion of the gear train between counter shaft 4 and axles 5 is defined as a deceleration gear train. The following description is based on the assumption that transaxle 1 serves as rear transaxle 1r having input shaft 3 faced horizontally forward in the fore-and-aft direction.

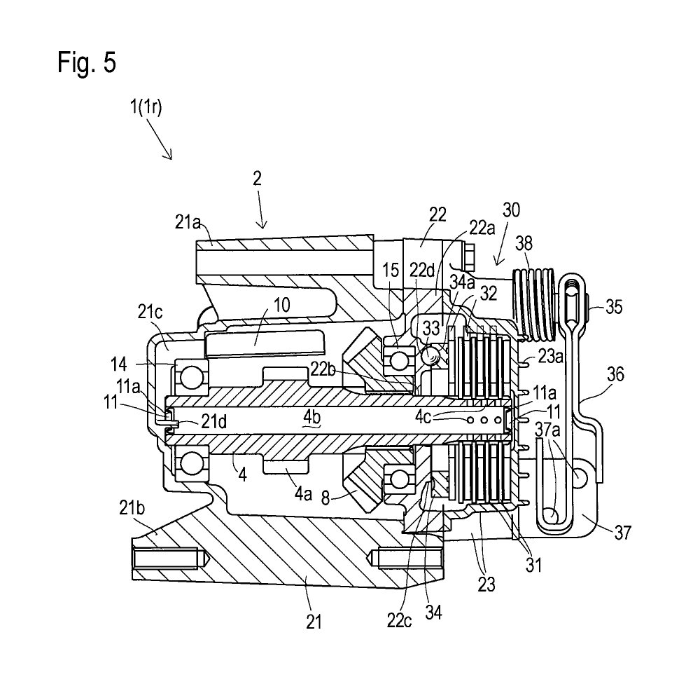

Transaxle casing 2 includes a main casing part 21 and a side cover 22 joined to each other. Side cover 22 is fastened to main casing part 21 by bolts. As shown in FIGS. 3 and 5, main casing part 21 is formed at an outer edge portion thereof integrally with a boss portion 21a having a lateral penetrating hole (in parallel to axles 5), and is formed at the opposite outer edge portion thereof integrally with a mount portion 21b having left and right bolt holes. When transaxle 1 is provided as rear transaxle 1r in the above-mentioned buggy, mount portion 21b is extended downward, and boss portion 21a is extended upward so as to be connected to rear suspension 63 (see FIG. 1) via a pivot pin passed through the penetrating hole. Mount portion 21b can be fastened to vehicle body frame 50 or another part by left and right bolts screwed into the respective left and right bolt holes, especially when transaxle 1 serves as front transaxle 1f.

Main casing part 21 has a front end opening, through which a bearing block 7 is fixedly fitted into main casing part 21. Input shaft 3 is journalled in bearing block 7 through bearings 12 and 13. A front end portion of input shaft 3 projects forward from a front end of bearing block 7 so as to be relatively unrotatably fitted thereon with a coupling 6 for connecting input shaft 3 to rear-wheel drive shaft 59r (or front-wheel drive shaft 59f, if transaxle 1 serves as front transaxle 1f). In transaxle casing 2, a rear end portion of input shaft 3 projects rearward from bearing block 7 so as to be formed thereon integrally with a bevel gear 3a.

A rear portion main casing part 21 and side cover 22 joined to main casing part 21 are provided with respective opposite left and right shaft holes for passing respective left and right axles 5 therethrough.

As discussed later, transaxle 1 can be made into either a differential type transaxle or a non-differential type transaxle. Transaxle 1 shown in FIG. 4 is the non-differential type transaxle. In this regard, axles 5 passed through the respective shaft holes of main casing part 21 and side cover 22 are spline-fitted at proximal ends thereof into a center boss portion of a final gear 9, so as to be rotatable integrally with final gear 9 (not differentially). Final gear 9 is a diametrically large spur gear. The center boss portion of final gear 9 is journalled at left and right ends thereof by main casing part 21 through a bearing 16, and by side cover 22 through a bearing 17.

As shown in FIG. 4 and others, a side wall of main casing part 21 is extended forward from the rear portion having the shaft hole passing axle 5, so as to support one end of lateral counter shaft 4 disposed in parallel to axles 5. Further, a fluid passage hole 21c is provided between the side wall of main casing part 21 and the one end of counter shaft 4 supported by the side wall of main casing part 21. As shown in FIGS. 4, 5, 7 and 9, side cover 22 is formed at an outer side portion thereof with a base portion 22a for mounting brake unit 30 thereon. A shaft hole 22b penetrates a wall of side cover 22 surrounded by base portion 22a so as to pass counter shaft 4 therethrough. Brake unit 30 mounted on base portion 22a has a brake chamber therein, and counter shaft 4 supported in transaxle casing 2 projects into the brake chamber through shaft hole 22b. In other words, the wall of side cover 22 having shaft hole 22b and base portion 22a therearound serves as a partition wall between the brake chamber and a later-discussed gear chamber in transaxle casing 2.

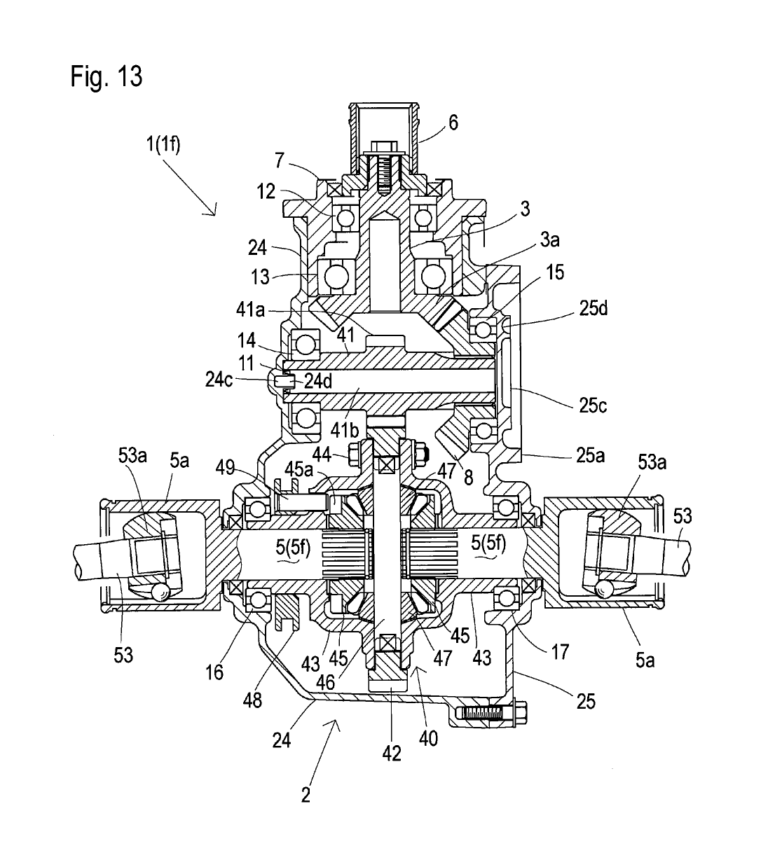

Alternatively, as discussed later with reference to FIG. 13, transaxle 1 may be provided without brake unit 30. In this case, since counter shaft 4 does not have to be extended outward from side cover 22, shaft hole 22b is not bored in side cover 22. That is, the corresponding wall of side cover 22 surrounded by base portion 22a is completely closed.

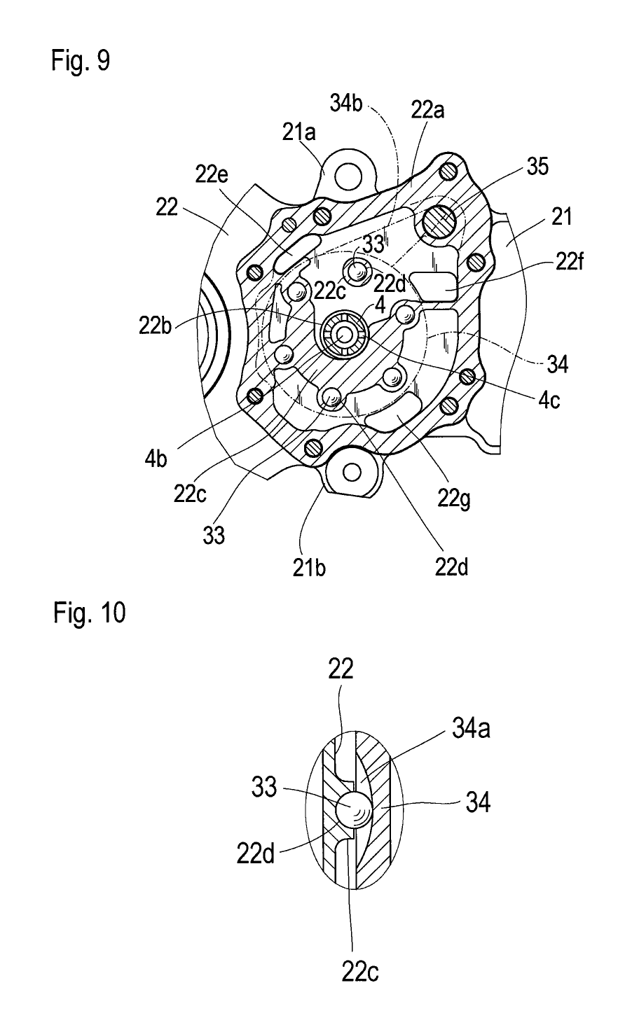

As shown in FIGS. 4, 9 and others, a cam plate portion 22c is formed on an outer side surface portion of the wall of side cover 22 around shaft hole 22b and surrounded by base portion 22a. Hemispherical recess 22d, laterally outwardly opened, are formed in cam plate portion 22c and are aligned on a peripheral line centered on shaft hole 22b.

Further, as shown in FIG. 9, upper, middle and lower connection holes 22e, 22f and 22g penetrate the side wall of side cover 22 surrounded by base portion 22a so as to be opened at one ends thereof into transaxle casing 2, i.e., the gear chamber, and opened at the other ends thereof into a brake casing 23 of brake unit 30, i.e., the brake chamber. The gear chamber is filled therein with fluid so as to serve as a fluid sump. Vertically middle connection hole 22f serves as a brake-lube supply passage for supplying lube to brake unit, so that fluid in the gear chamber of transaxle casing 2 agitated and splashed by rotating gears is guided into the brake chamber of brake casing 23 through connection hole 22f. Connection hole 22g is disposed lower than connection 22f so as to serve as a lube return passage for returning fluid from the brake chamber of brake casing 23 into the gear chamber of transaxle casing 2. The highest connection hole 22e serves as a vent hole through which air is introduced into transaxle casing 2 so as to smoothen the circulation of lube between the gear chamber and the brake chamber through connection holes 22f and 22g, and smoothen later-discussed supply of lube to brake unit 30 through counter shaft 4.

When transaxle 1 is provided without brake unit 30, the side wall of side cover 22 is not bored with connection holes 22e, 22f and 22g, thereby enclosing the gear chamber in transaxle casing 2. In other words, the side wall of side cover 22 is adapted to be easily bored with shaft hole 22b and connection holes 22e, 22f and 22g when brake unit 30 is mounted onto side cover 22.

In transaxle casing 2, a bevel gear 8 is spline-fitted on counter shaft 4 along an inner side surface of side cover 22 so as to mesh with bevel gear 3a of input shaft 3. Bevel gear 8 is journalled by side cover 22 through a bearing 15 adjacent to cam plate portion 22c. On the lateral opposite side of bearing 15 and shaft hole 22b, a bearing 14 is provided on an end portion of counter shaft 4 and is supported by a side wall of main casing part 21. Fluid passage hole 21c is bored in the side wall of main casing part 21 adjacent to bearing 14. A pinion 4a is peripherally formed on counter shaft 4 between bearing 14 and bevel gear 8. Pinion 4a and final gear 9 mesh with each other so as to constitute the deceleration gear train (deceleration gears) disposed in the gear chamber of transaxle casing 2.

In the deceleration gear train, pinion 4a and final gear 9 are inexpensive spur gears while they have different diameters, i.e., final gear 9 is diametrically larger than pinion 4a. On the other hand, bevel gears 3a and 8 are expensive in comparison with spur gears. However, due to the deceleration gears 4a and 9, bevel gears 3a and 8 can be configured so as to have one-to-one gear ratio therebetween, thereby having a backlash therebetween to be easily adjusted. The easy adjustability of backlash between bevel gears 3a and 8 is advantageous in reduction of costs.

As mentioned above, the fluid sump is provided in the gear chamber of transaxle casing 2 incorporating gears 3a, 8, 4a and 9 and bearings 13, 14, 15, 16 and 17, so as to lubricate the gears and bearings in the gear chamber. Counter shaft 4 is a hollow shaft having an axial penetrating hole 4b. Hole 4b is opened at one end thereof in main casing part 21 to the fluid sump through fluid passage hole 21c. Due to hole 4b, counter shaft 4 is lightened, and is used as a connection pipe interposed between the gear chamber and the brake chamber so as to supply lube from the fluid sump in the gear chamber to brake unit 30.

With respect to transaxle 1 provided with brake unit 30, a structure for supplying lube to brake unit 30 will be described with reference to FIGS. 4 to 9. Counter shaft 4 is provided with holes 4c extended radially from axial hole 4b in a portion thereof in brake unit 30. Radial holes 4c are opened on an outer peripheral surface of counter shaft 4 so as to face rotatable friction disks 31 and fixed friction disks 32 provided around counter shaft 4 as discussed later.

Fluid passage hole 21c has an opening opened to the gear chamber in main casing part 21. A fluid introduction gutter 10 is extended into the gear chamber from a lower portion of the opening of fluid passage hole 21c. In this embodiment, fluid introduction gutter 10 is a L-bent metal plate which is a different member from main casing part 21. Alternatively, main casing part 21 may be formed with a portion extended so as to serve as fluid introduction gutter 10. Fluid introduction gutter 10 is extended so as to face pinion 4a. A part of fluid (lube) agitated and splashed by rotating pinion 4a and final gear 9 is collected into fluid introduction gutter 10 and guided into fluid passage hole 21c.

A pair of rings 11 are fitted in respective opposite opened ends of axial hole 4c of counter shaft 4. Rings 11 are made of elastic material such as rubber. Each ring 11 has a turn end 11a between outer and inner peripheral ends thereof. Turn end 11a is disposed outward from the outer and inner peripheral ends of ring 11 in the axial direction of hole 4b. In other words, the outer and inner peripheral ends of ring 11 are directed axially inward of hole 4b (toward the axial middle portion of hole 4b), and turn end 11a is directed axially outward of hole 4b (toward each end of hole 4b). A wall of side cover 22 corresponding to an exit of fluid passage hole 21c is extended into hole 4b of counter shaft 4 so as to form a gutter portion 21d, onto which the inner peripheral end of one ring 11 is fitted, thereby smoothening introduction of fluid from fluid passage hole 21c into hole 4b of counter shaft 4 and flow of fluid along hole 4b to the opposite side.

Due to the centrifugal force of rotating counter shaft 4, fluid in hole 4b is pressed against the inner peripheral surface of hole 4b. Each ring 11 has a backspace of turn end 11a between the outer and inner peripheral ends thereof. Fluid introduced from fluid passage hole 21c into hole 4b is collected into the backspace of ring 11 at the end of counter shaft 4 in main casing part 21. When counter shaft 4 is rotated, the fluid collected in the backspace of ring 11 opened to fluid passage hole 21c is flowed along the inner peripheral surface of hole 4b toward the opposite end of counter shaft 4 in brake unit 30, and is supplied to rotatable friction disks 31 and fixed friction disks 32 through radial holes 4c.

Due to turn end 11a of ring 11 disposed at the opposite open end of hole 4b of counter shaft 4 in brake unit 30, the fluid flowing along the inner peripheral surface of hole 4b is prevented from escaping from the hole 4b through the opposite open end of hole 4b into a space of the brake chamber out of rotatable friction disks 31 and fixed friction disks 32. That is, turn end 11a of ring 11 disposed in brake unit 30 stops the flow of fluid, accumulates the fluid in the backspace thereof, and turns fluid toward transaxle casing 2, so as to ensure a sufficient amount of fluid in hole 4b, thereby efficiently supplying fluid, serving as lube, through radial holes 4c to rotatable friction disks 31 and fixed friction disks 32 of brake unit 30 externally mounted on transaxle casing 2.

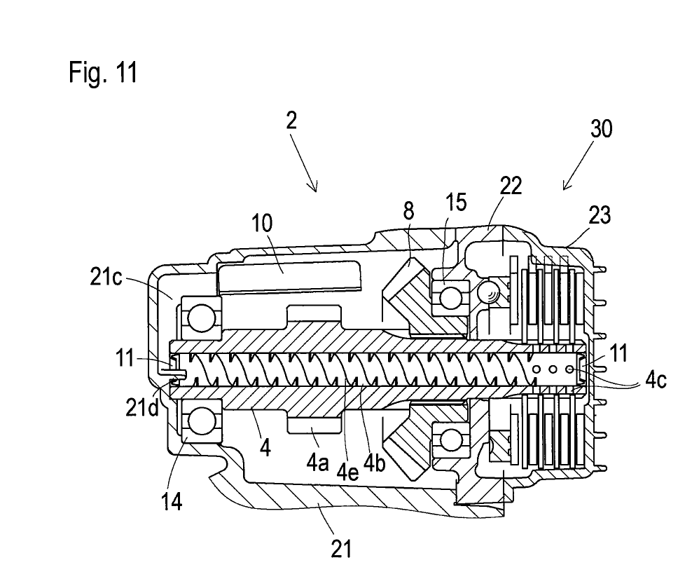

In an alternative embodiment shown in FIG. 11, a spiral belt 4e is attached onto the inner peripheral surface of axial hole 4b of counter shaft 4 so as to forcibly move fluid from the open end of hole 4b in main casing part 21 to the opposite open end of hole 4b in brake unit 30. Alternatively, a spiral groove may be formed on the inner peripheral surface of hole 4b for the same purpose.

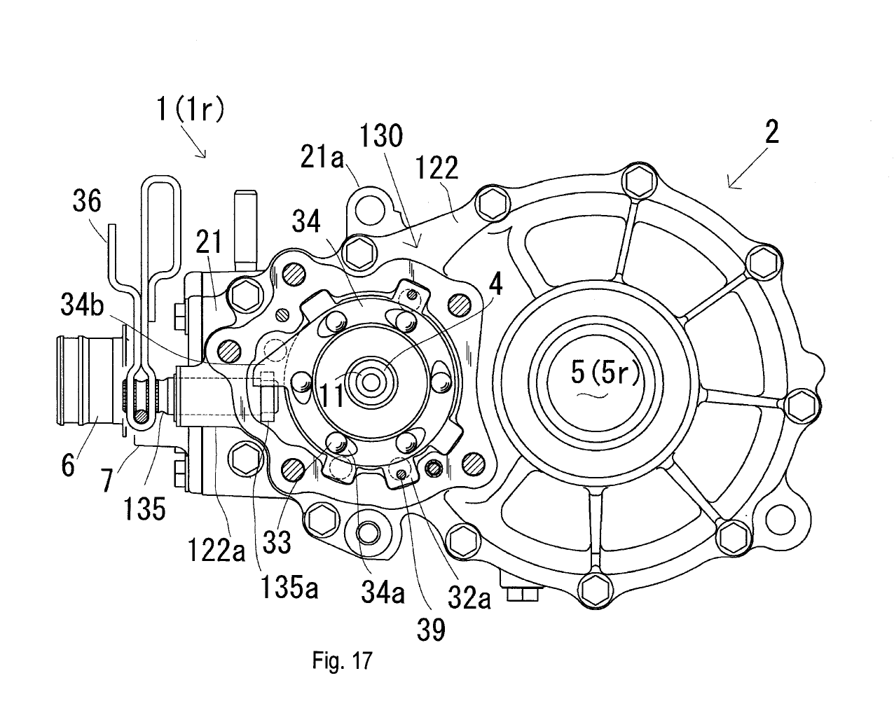

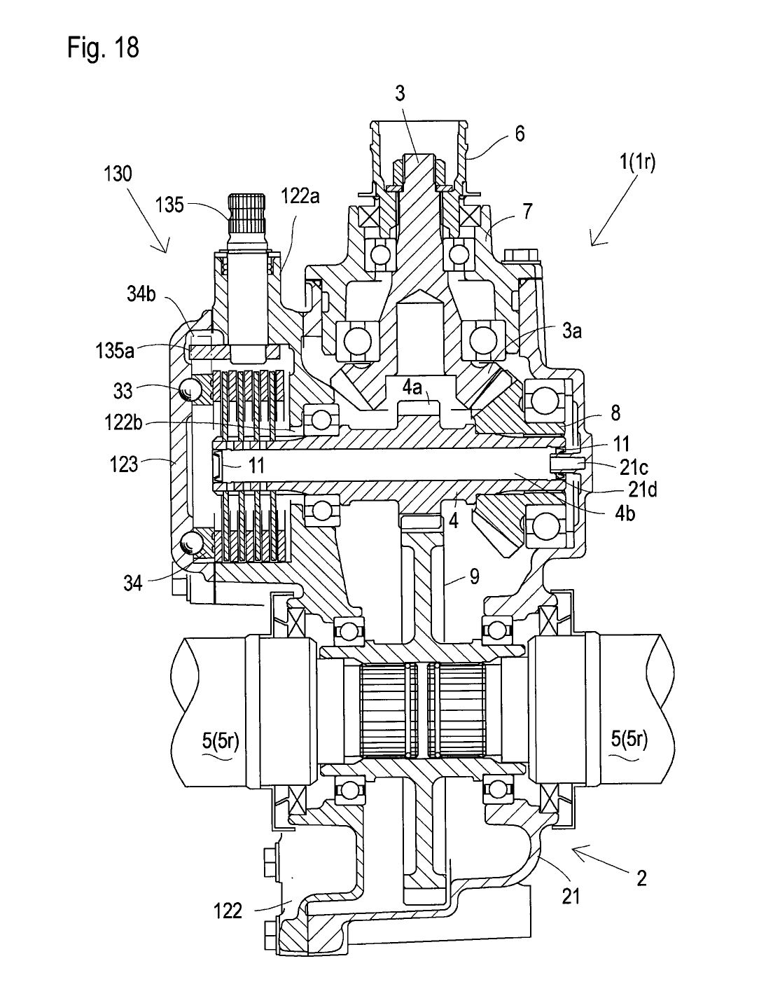

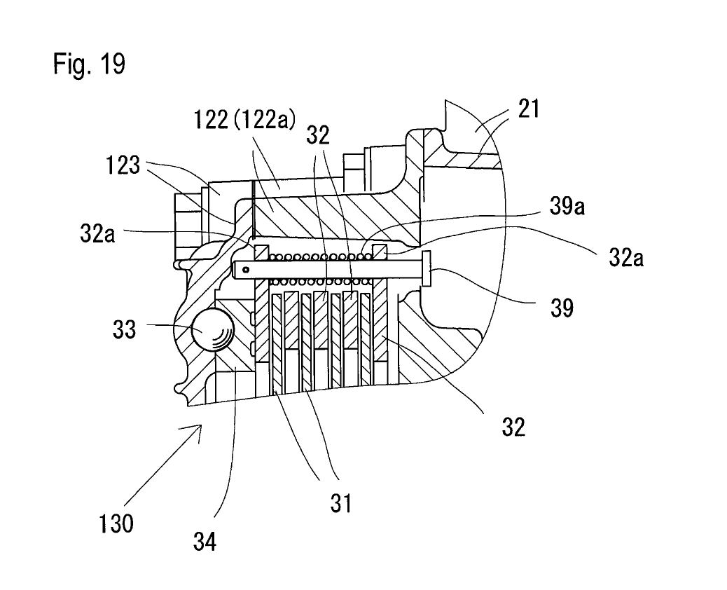

Brake unit 30 will be described with reference to FIGS. 3 to 5, 7, 9, 10, 17 to 19. It should be noticed that FIGS. 17 to 19 show an alternative bake unit 130 provided on transaxle 1, and brake unit 130 shown in FIGS. 17 to 19 corresponds to laterally reversed brake unit 30 of the present embodiment shown in FIGS. 3 to 5, 7, 9 and 10. Brake casing 23 is fixedly fitted on base portion 22a of side cover 22. A plurality of substantially horizontal fins 23a are formed on outer side surfaces of brake casing 23 so as to cool brake unit 30. In brake casing 23, rotatable friction disks 31 are axially slidably and relatively unrotatably spline-fitted on the portion of counter shaft 4 projecting from transaxle casing 2. Fixed friction disks 32 are disposed so that each fixed friction disk 32 is disposed between neighboring rotatable friction disks 31. Thus, rotatable friction disks 31 and fixed friction disks 32 are alternately aligned along counter shaft 4. As mentioned above, radial holes 4c of counter shaft 4 are opened to face rotatable friction disks 31 and fixed friction disks 32.

Brake unit 30 has the same feature of brake unit 130 shown in FIGS. 17 to 19 as follows, however, the feature is not shown in FIGS. 3 to 5, 7, 9 and 10. Pawl portions 32a are extended radially from an outer peripheral edge of each fixed friction disk 32, and are engaged into corresponding recesses formed on brake casing 23, so as to axially slidably and relatively unrotatably fit each fixed friction disk 32 to brake casing 23. Further, in the alignment of rotatable friction disks 31 and fixed friction disks 32, one fixed friction disk 32 is disposed at the proximal end of the alignment (hereinafter, this fixed friction disk 32 is referred to as “the most proximal fixed friction disk 32”, another fixed friction disk 32 is disposed at the distal end of the alignment (hereinafter, this fixed friction disk 32 is referred to as “the most distal fixed friction disk 32”), and the most proximal and distal fixed friction disks 32 are relatively slidably connected to each other through one or more connection pins 39, each of which is relatively slidably interposed between optionally selected pawl portions 32a of the most proximal and distal fixed friction disks 32. Between the most proximal and distal fixed friction disks 32, a compressed spring 39a is wound around each connection pin 39, so as to press the two fixed friction disks 32 away from each other, thereby biasing all rotatable friction disks 31 and fixed friction disks 32 to separate from one another. Due to this structure, when brake unit 30 is operated for unbraking, rotatable friction disks 31 and fixed friction disks 32 are swiftly separated from one another so as to swiftly release axles 5 from the braking force.

Cam balls 33 are fitted at halves thereof into respective recesses 22d opened at the outer side surface of cam plate portion 22c of side cover 22. In the alignment of rotatable friction disks 31 and fixed friction disks 32, the most proximal fixed friction disk 32 is nearest to the outer side surface of cam plate portion 22c. A cam ring 34 is rotatably disposed between cam plate portion 22c of side cover 22 and the most proximal fixed friction disk 32. Cam grooves 34a are formed in cam ring 34 to be opened toward cam plate portion 22c, and are aligned on a periphery centered on the center axis of counter shaft 4 so as to correspond to respective recesses 22d, and to accommodate the other halves of cam balls 33. As shown in FIG. 10, each of cam grooves 34a is extended along the periphery so as to be longer than the diameter of cam ball 33. Each cam groove 34a has opposite shallowest ends in the periphery direction, and has a deepest center portion. The depth of cam groove 34a gradually increases as it goes from each of the shallowest ends to the deepest center portion.

According to rotation of cam ring 34, when cam balls 33 reach the deepest center portions of respective cam grooves 34a, a gap between cam ring 34 and cam plate portion 22c of side cover 22 is minimized so as to separate rotatable friction disks 31 and fixed friction disks 32 from one another, thereby setting brake unit 30 into an unbraking state. On the contrary, when cam balls 33 reach the shallowest ends of respective cam grooves 34a, cam balls 33 push cam ring 34 away from cam plate portion 22c of side cover 22, and maximize the gap between cam ring 34 and cam plate portion 22c of side cover 22, so as to press rotatable friction disks 31 and fixed friction disks 32 against one another, thereby setting brake unit 30 into a braking state.

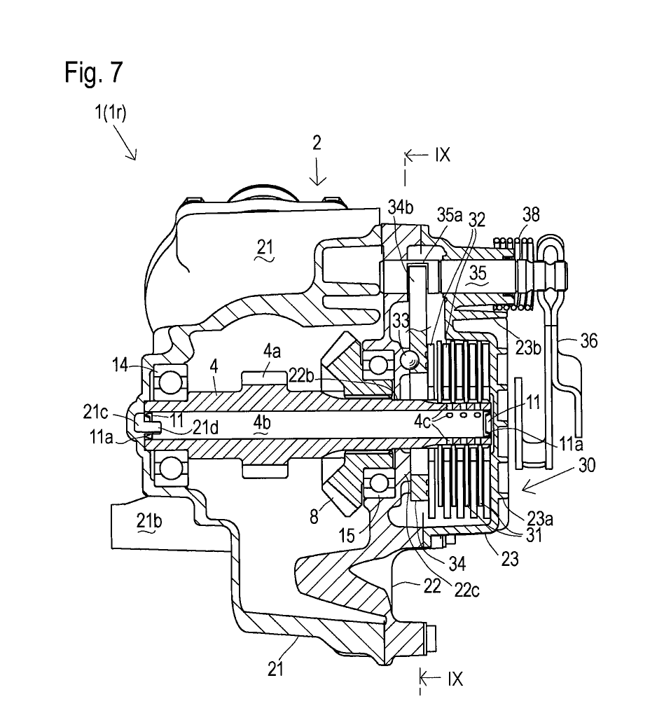

As shown in FIG. 7, a brake shaft 35 is disposed in parallel to counter shaft 4, and is supported between side cover 22 and brake casing 23. Brake shaft 35 projects outward from brake casing 23 so as to be fixedly provided on an outer end thereof with a brake arm 36. In the buggy shown in FIGS. 1 and 2, a brake lever is provided on handlebar 55, and is connected to brake arm 36 through a wire. In this regard, a wire stay 37 having a guide hole 37a is fixed on an outer side of brake casing 23 so as to guide the wire through guide hole 37a.

Brake arm 36 is rotated by operating the bake lever so as to be switched between an unbraking position for setting brake unit 30 into the unbraking state and a braking position for setting brake unit 30 into the braking state. A return spring 38 is interposed between brake arm 36 and a spring stay 23b formed on brake casing 23, and is wound around the projecting end of brake shaft 35 and a boss portion of brake casing 23 supporting brake shaft 35, so as to bias brake arm 36 and brake shaft 35 toward the unbraking position.

In side cover 22 and brake casing 23, cam ring 34 is formed with an arm 34b, which is extended outward from the outer peripheral edge of cam ring 34 so as to have a surface facing brake shaft 35. Brake shaft 35 is partly cut off so as to have a cam surface 35a facing arm 34b. When brake arm 36 is disposed at the unbraking position, cam surface 35a is disposed in parallel to the surface of arm 34b facing cam surface 35a, so as to locate cam ring 34 for setting brake unit 30 into the unbraking state. When brake arm 36 is rotated to the braking position, brake shaft 35 rotates together with brake arm 36 and cam surface 35a is disposed slantwise to the surface of arm 34b, so as to push arm 34b and rotate cam ring 34, thereby setting brake unit 30 into the braking state.

The foregoing transaxle 1 is an embodiment of non-differential type transaxle 1 with brake unit 30, having left and right axles 5 rigidly (not-differentially) connected to each other so as to be adaptable as rear transaxle 1r for the buggy shown in FIGS. 1 and 2.

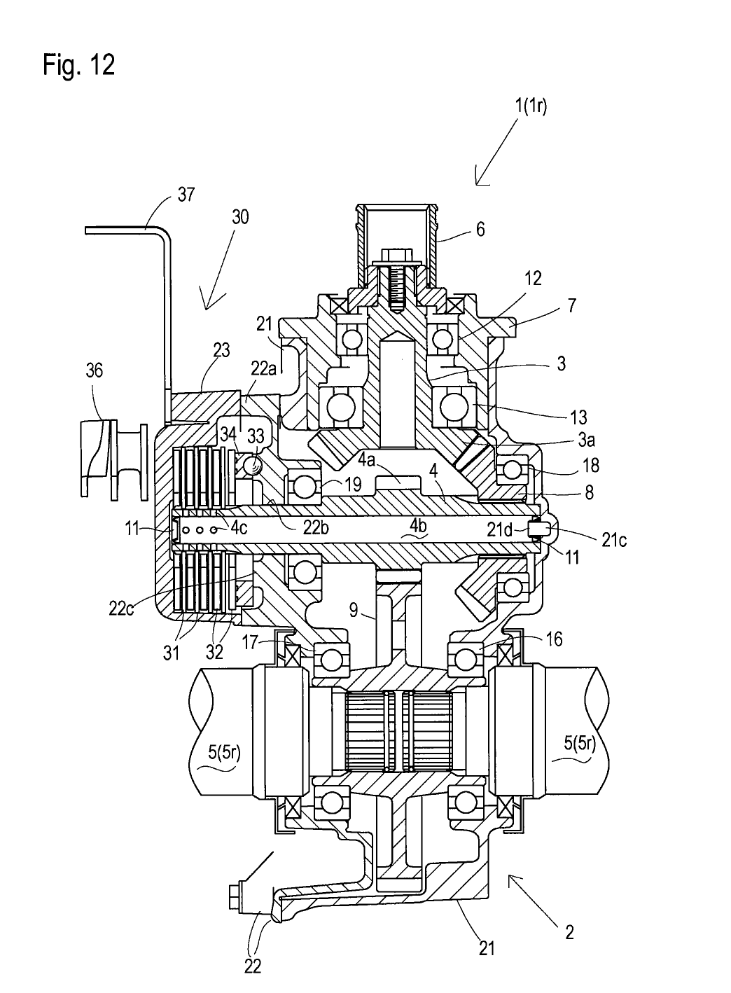

To adapt transaxle 1 to a vehicle without interference with an obstacle, the position of brake unit 30 relative to transaxle casing 2 may be preferred to be laterally opposite to that shown in FIGS. 1 to 4 in some cases. In an alternative transaxle 1 shown in FIG. 12, main casing part 21 and side cover 22 are laterally reversed to those shown in FIGS. 3 to 10 so as to constitute transaxle casing 2 of transaxle 1 shown in FIG. 12. Thus, in comparison with transaxle 1 with brake unit 30 shown in FIGS. 3 to 10, transaxle 1 of FIG. 12 has laterally reversed brake unit 30 mounted on side cover 22 at the lateral opposite side portion of transaxle casing 2.

Whether transaxle 1 may have brake unit 30 mounted on the left side of transaxle casing 2 or on the right side of transaxle casing 2, brake unit 30 is externally attached onto one of the opposite sides of transaxle casing 2 in the lateral direction parallel to axles 5, so that brake unit 30 is detachable for maintenance thereof without requiring disassembling of the transmission interposed between input shaft 3 and axles 5 disposed perpendicular to input shaft 3. The transmission includes the gear train of bevel gears 3a and 8 between input shaft 3 and counter shaft 4, and includes the deceleration gear train of gears 4a and 9 between counter shaft 4 and axles 5. Only by detaching brake casing 23 from base portion 22a of side cover 22, the interior of brake unit 30 is easily exposed so as to facilitate disassembling thereof for maintenance while the other transmission components in transaxle 1 are left untouched.

In the embodiment of FIG. 12, bevel gear 8 is spline-fitted on one end portion of counter shaft 4 in main casing part 21, and is supported by main casing part 21 through a bearing 18. Counter shaft 4 is supported at an intermediate portion thereof by side cover 22 through a bearing 19. Alternatively, similar to counter shaft 4 shown in FIG. 4, the end portion of counter shaft 4 facing fluid passage hole 21c may be supported by main casing part 21 through bearing 14, and bevel gear 8 may be spline-fitted on counter shaft 4 so as to be supported by side cover 22 through bearing 15.

An alternative transaxle 1 shown in FIG. 13 is adaptable as front transaxle 1f for the buggy shown in FIGS. 1 and 2. Transaxle 1 of FIG. 13 is provided without brake unit 30, and it is differential type transaxle 1 having left and right axles 5 differentially connected to each other. When transaxle 1 of FIG. 13 is adapted as front transaxle 1f to a vehicle, fore-and-aft input shaft 3 is faced rearward, and left and right lateral axles 5 are disposed in front of input shaft 3. Only distinctions of transaxle 1 of FIG. 13 from transaxle 1 shown in FIGS. 3 to 10 will be described as follows.

In transaxle 1 of FIG. 13, a differential gear unit 40 is disposed in transaxle casing 2 so as to differentially connect left and right axles 5 to each other. Instead of long counter shaft 4 projecting outward from transaxle casing 2, a short counter shaft 41 is entirely disposed in transaxle casing 2.

Short counter shaft 41 corresponds to a remaining portion of long counter shaft 4 from which a portion thereof projecting from side cover 22 into brake unit 30 has been removed. Similar to counter shaft 4, bevel gear 8 is provided on an end portion of counter shaft 41 toward side cover 22, and meshes with bevel gear 3a. A spur pinion 41a is formed on a lateral center portion of counter shaft 41. An axial hole 41b axially penetrates counter shaft 41. In transaxle 1 shown in FIG. 13, axial hole 41b is not required to have the function for supplying fluid to brake unit 30, however, it effects lightening of counter shaft 4. Further, axial hole 41b and pinion 41a can be economically formed in counter shaft 4 by use of the same processing device for forming axial hole 4b and pinion 4a in counter shaft 4.

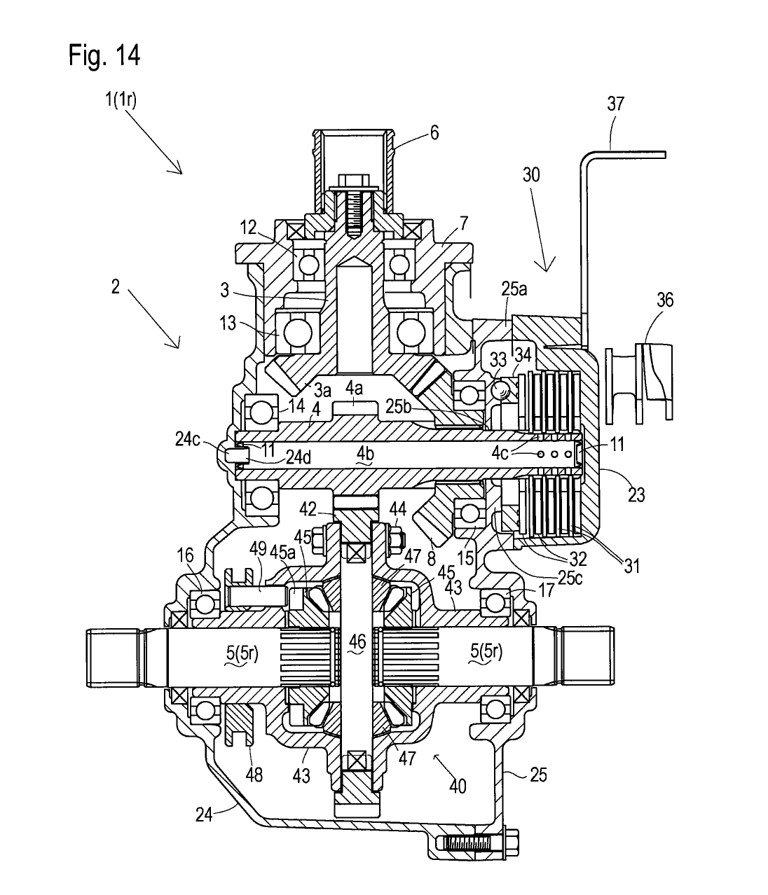

Transaxle casing 2 of transaxle 1 including differential gear unit 40 includes a main casing part 24 and a side cover 25 joined to each other. In comparison with main casing part 21 and side cover 22 of transaxle casing 2 of non-differential type transaxle 1, the only distinction is that main casing part 24 and side cover 25 have laterally outwardly expanded portions for supporting respective axles 5 with differential gear unit 40 therebetween. Main casing part 24 is formed with portions (not shown) corresponding to boss portion 21a and mount portion 21b of main casing part 21, and is formed with a fluid passage hole 24c and a gutter portion 24d, as shown in FIG. 13, corresponding to fluid passage hole 21c and gutter portion 21d of main casing part 21, respectively. Side cover 25 is formed with a base portion 25a, a cam plate portion 25c and recesses 25d so as to correspond to base portion 22a, cam plate portion 22c and recesses 22d of side cover 22. If differential type transaxle 1 is provided with brake unit 30, a shaft hole 25b, as shown in FIG. 14, can be easily bored through cam plate portion 25c of side cover 25 so as to correspond to shaft hole 22b for passing long counter shaft 4 therethrough.

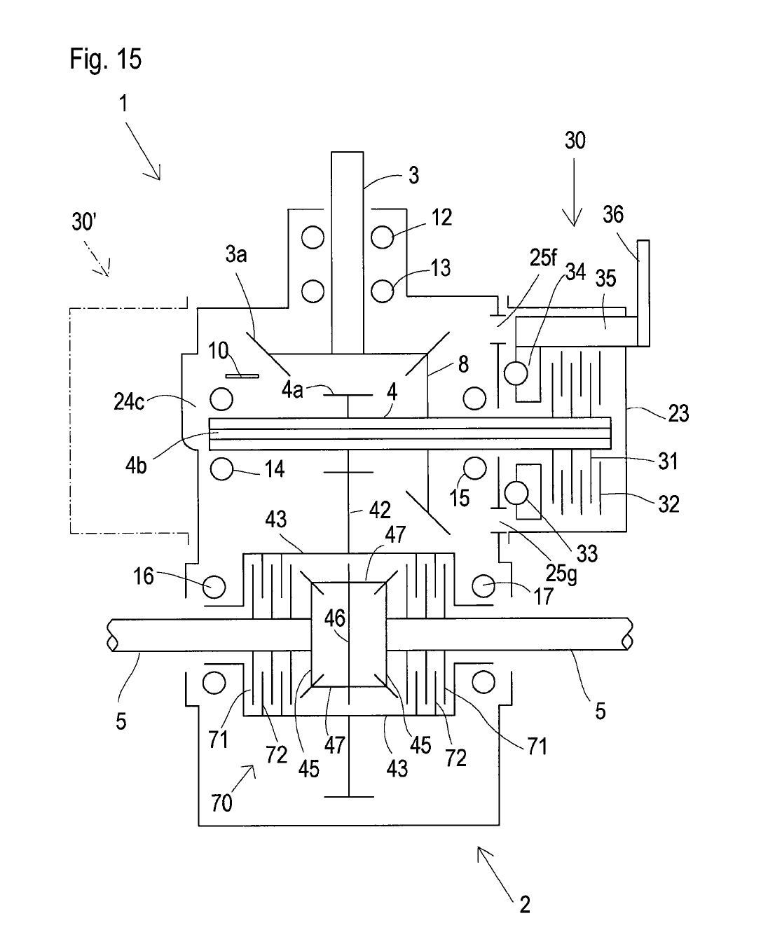

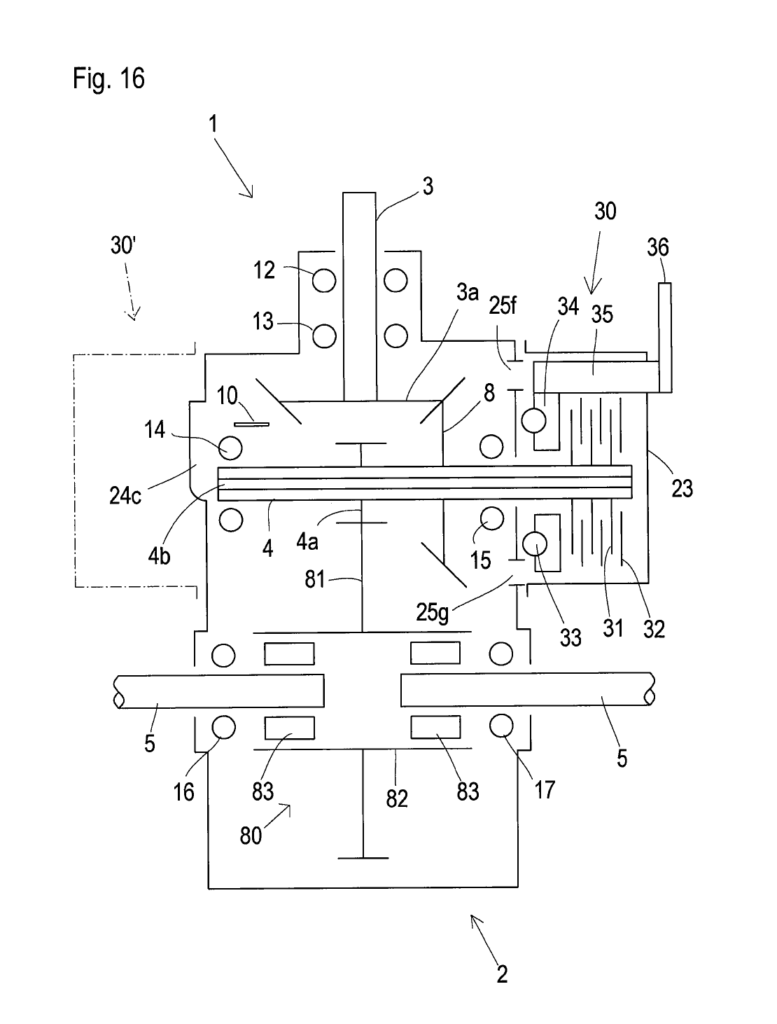

In correspondence to connection holes 22f and 22g of side cover 22, connection holes 25f and 25g, as shown in FIGS. 15 and 16, are formed in side cover 25 so as to circulate fluid between the gear chamber of transaxle casing 2 and the brake chamber of brake unit 30 therethrough. Further, a vent hole (not shown) corresponding to hole 22e is bored in side cover 25 so as to smoothen the circulation of fluid through connection holes 25f and 25g.

A final gear 42 meshing with pinion 41a is a diametrically large spur gear, which serves as an input gear of differential gear unit 40. Differential gear unit 40 includes a pair of left and right differential cages 43 each of which is provided around each axle 5 (in this embodiment, front axle 5f) between final gear 42 and either main casing part 24 or side cover 25. Each differential cage 43 is formed at a laterally (axially) distal end portion thereof with a boss, relatively rotatably fitted on each of axles 5. The boss of one differential cage 43 is fitted between one axle 5 and the lateral expanded boss portion of main casing part 24 through bearing 16. The boss of the other differential cage 43 is fitted between the other axle 5 and the lateral expanded boss portion of side cover 25 through bearing 17. Differential cages 43 are fastened at laterally (axially) proximal ends thereof to respective left and right side surfaces of final gear 42 by bolts 44.

A pair of differential side gears 45 are fixed on proximal ends of respective axles 5 in respective differential cages 43. A pinion shaft 46 is diametrically supported in final gear 42, and opposite differential pinions 47 are provided on pinion shaft 46 so that each differential pinion 47 meshes with both differential side gears 45.

Differential gear unit 40 is provided with a differential lock mechanism. In this regard, a differential lock slider 48 is axially slidably fitted on the boss of one of differential cages 43. Differential cage 43 provided with differential lock slider 48 is bored by pin holes, and differential lock pins 49 are extended from differential lock slider 48 in parallel to axle 5 and are inserted into the respective pin holes of differential cage 43. Differential side gear 45 in this differential cage 43 is formed with recesses 45a corresponding to respective differential lock pins 49. Due to axial slide of differential lock slider 48, differential lock pins 49 are inserted into respective recesses 45a, or are withdrawn from respective recesses 45a. FIG. 13 illustrates differential lock slider 48 disposed at a differential position where differential lock pins 49 are disposed outward from recesses 45a so as to allow differential side gear 45 fixed to axle 5 to rotate relative to differential cage 43 fixed to final gear 42, thereby allowing differential rotation of left and right axles 5. When differential lock slider 48 slides rightward from the differential position illustrated in FIG. 13 and reaches a differential lock position, differential lock pins 49 are inserted into respective recesses 45a so as to lock differential cage 43 to differential side gear 45, thereby locking axles 5 to each other, i.e., preventing axles 5 from differentially rotating.

Transaxle 1 shown in FIG. 13 is adaptable as front transaxle if to the buggy shown in FIGS. 1 and 2. Left and right axles 5 (front axles 5f) are formed at distal ends thereof with respective couplings 5a. Left and right front extension axles 53 are provided at proximal ends thereof with respective universal joints 53a, which are fitted into respective couplings 5a so as to drivingly connect respective front axles 5f to respective front wheels 52f vertically swingably suspended by respective front suspensions 64.

Transaxle 1 shown in FIG. 14 is differential type transaxle 1 provided with brake unit 30 so as to be adaptable as rear transaxle 1r to the buggy shown in FIGS. 1 and 2. The distinction of transaxle 1 shown in FIG. 14 from transaxle 1 shown in FIG. 13 adaptable as front transaxle 1f is brake unit 30 mounted on an outside of side cover 25 in the same way of brake unit 30 mounted on side cover 22 as shown in FIGS. 3 to 10. In this regard, side cover 25 is bored by shaft hole 25b as mentioned above, and long counter shaft 4 is supported in transaxle casing 2 and is extended at an end portion thereof into brake unit 30 through shaft hole 25b. Axles 5 (rear axles 5r) are rigidly and coaxially connected at distal ends thereof to respective rear extension axles 61.

If a buggy is provided with differential type rear transaxle 1r as shown in FIG. 14 in addition to differential type front transaxle 1f as shown in FIG. 13, transaxle casings 2 of respective front and rear transaxles 1f and 1r can be economically standardized so that each of transaxle casings 2 includes main casing part 24 and side cover 25 joined to each other. In other words, transaxle casing 2 including main casing part 24 and side cover 25 can be selectively provided with brake unit 30 or without brake unit 30 depending on whether side cover 25 is bored with shaft hole 25b (and connection holes 25f and 25g) or not.

Both front and rear transaxles 1f and 1r may be non-differential transaxles 1. In this case, transaxle casings 2 of respective front and rear transaxles 1f and 1r can be economically standardized so that each of transaxle casings 2 includes main casing part 21 and side cover 22 joined to each other. Whether each of front and rear transaxles 1f and 1r may be the differential type or the non-differential type, front transaxle 1f may be provided with brake unit 30 while rear transaxle 1r is provided without brake unit 30. Alternatively, both front and rear transaxles 1f and 1r may be provided with respective brake units 30. Alternatively, both front and rear transaxles 1f and 1r may be provided without brake unit 30.

Each of differential type transaxles 1 shown in FIGS. 13 and 14 may have laterally reversed main casing part 24 and side cover 25 so as to be adapted to have brake unit 30 mounted on the laterally opposite side to the side shown in FIG. 14.

FIGS. 15 and 16 illustrate respective alternative transaxles 1 having alternative differential units disposed in respective transaxle casings 2. Each of transaxles 1 shown in FIGS. 15 and 16 is provided with brake unit 30 and corresponding long counter shaft 4, however, it may be provided without brake unit 30, or it may be provided on a laterally opposite side thereof with laterally reversed brake unit 30 (designated by a reference numeral 30 in FIGS. 15 and 16).

Transaxle 1 of FIG. 15 includes a differential-rotation-sensing (or torque-sensing) limited slip differential gear unit 70. In differential gear unit 70, alternately aligned friction disks 71 and 72 are interposed between each differential cage 43 and corresponding axle 5. Friction disks 71 are relatively unrotatably engaged to each axle 5, and friction disks 72 are relatively unrotatably engaged to each differential cage 43, so that each pair of neighboring friction disks 71 and 72 relatively rotatably and frictionally abut against each other. Therefore, even if one axle 5 is stuck and drive force is concentrated to the other axle 5, the friction between friction disks 71 and 72 restricts the differential rotatability of axles 5, whereby stuck axle 5 can also receive sufficient drive force to escape from the stuck state.

Transaxle 1 of FIG. 16 includes an automatic differential-lockable differential gear unit 80. In differential gear unit 80, a final pinion 81 meshes with pinion 4a, and is peripherally fixed on a clutch casing 82 having left and right openings through which left and right axles are inserted at proximal end portions thereof into clutch casing 82. Differential gear unit 80 includes a pair of dual direction clutches 83 each of which is interposed between clutch casing 82 and each axle 5. An alternative gearless type automatic differential-lockable differential unit may be provided to transaxle 1.

An alternative transaxle 1 shown in FIGS. 17 to 19 is provided with brake unit 130. The structure of brake unit 130 is almost the same as that of brake unit 30 having been described referring to FIGS. 3 to 5, 7, 9, 10, 17 to 19. Only the distinction of brake unit 130 from brake unit 30 will be described. Brake unit 130 is provided with a brake shaft 135 that is perpendicular to counter shaft 4 and parallel to input shaft 3. On the assumption that transaxle 1 shown in FIGS. 17 to 19 serves as rear transaxle 1r for the buggy as shown in FIGS. 1 and 2, brake shaft 135 is extended forward, and has an exposed front end on which brake arm 36 is fixed. Consequently, brake arm 36 on brake shaft 135 is laterally rotatable, in comparison with fore-and-aft rotatable brake arm 36 on brake shaft 35. In a brake chamber of brake unit 130, an inner arm 135a is extended radially (perpendicular to input shaft 3) from an inner end of brake shaft 135, and abuts against arm 34b. Biasing means (not shown) is provided to brake unit 130 so as to press arm 34b against arm 135a. When brake shaft 135 is rotated for braking, arm 135a pushes arm 34b against the biasing force of the biasing means so as to rotate cam ring 34 in the direction to press rotatable friction disks 31 and fixed friction disks 32 against one another.

Further, in the embodiment shown in FIGS. 17 to 19, transaxle casing 2 includes main casing part 21 and a side cover 122 joined to each other, and side cover 122 is formed with a brake chamber portion 122a having a laterally outwardly opened recess serving as a brake chamber, in which rotatable friction disks 31, fixed friction disks 32, connection pin 39 and spring 39a are disposed. A brake cover 123 is fixed to the opened end of brake chamber portion 122a so as to cover the components of brake unit 130 in the brake chamber. A wall of side cover 122 partitioning the brake chamber from the gear chamber formed by mutually joined main casing part 21 and side cover 122 is bored throughout by a shaft hole 122b, through which counter shaft 4 is passed between the brake chamber and the gear chamber. If brake unit 130 is not provided, the wall of side cover 122 may be provided without shaft hole 122b, i.e., it may be left closed.

In this embodiment, main casing part 21 and side cover 122 may be laterally reversed so as to mount brake unit 130 on the laterally opposite side of transaxle casing 2. Further, non-differential type transaxle 1 provided with brake unit 130 shown in FIGS. 17 to 19 may be changed into differential type transaxle 1 similar to that shown in FIG. 14.

It is further understood by those skilled in the art that the foregoing description is a preferred embodiment of the disclosed device and that various changes and modifications may be made in the invention without departing from the scope thereof defined by the following claims.

What is claimed is:

1. A transaxle for an all-terrain vehicle, comprising:
an axle;
an input shaft disposed perpendicular to the axle;
a transmission interposed between the input shaft and the axle; and
a transaxle casing incorporating the axle, the input shaft and the transmission, wherein one of opposite side portions of the transaxle casing in a direction parallel to the axle is provided for detachably mounting a brake unit thereon.

2. The transaxle according to claim 1, the transmission comprising:
a gear train including a counter shaft disposed in the transaxle casing in parallel to the axle and between the input shaft and the axle, wherein, when the brake unit is mounted on the side portion of the transaxle casing, an outer end portion of the counter shaft is disposed in the brake unit.

3. The transaxle according to claim 2, further comprising:
a wall of the side portion of the transaxle casing for mounting the brake unit thereon, wherein the wall is adapted to be bored with a shaft hole for passing the counter shaft therethrough when the brake unit is mounted on the transaxle casing.

4. The transaxle according to claim 2, further comprising:
a fluid sump provided in the transaxle casing;
a hole axially penetrating the counter shaft so as to have first and second opened ends, wherein the first end is opened to the fluid sump, and the second end is opened to the brake unit; and
fluid introduction means disposed adjacent to the first end so as to introduce fluid from the fluid sump to the brake unit through the hole.

5. The transaxle according to claim 1, further comprising:
a wall of the side portion of the transaxle casing for mounting the brake unit thereon, wherein the wall is adapted to be easily bored with a hole for passing fluid therethrough between the transaxle casing and the brake unit when the brake unit is mounted on the transaxle casing.

6. The transaxle according to claim 1, wherein the brake unit includes a brake casing attached to the side portion of the transaxle casing, and wherein the brake casing has an outer surface formed thereon with fins.
